(19) United States
(12) Patent Application Publication
(10) Pub. No.: US 2006/0275539 A1
(43) Pub. Date: Dec. 7, 2006

(54) TRANSPARENT CONDUCTIVE FILM AND METHOD FORMING THEREOF, ELECTROOPTIC DEVICE AND ELECTRONIC APPARATUS

(75) Inventors: Toshimitsu HIRAI, Suwa (JP); Katsuyuki MORIYA, Suwa (JP)

Correspondence Address: HARNESS, DICKEY & PIERCE, P.L.C., P.O. BOX 828, BLOOMFIELD HILLS, MI, 48303, US

(73) Assignee: Seiko Epson Corporation, Tokyo (JP)

(21) Appl. No.: 11/382,094

(22) Filed: May 8, 2006

(30) Foreign Application Priority Data
May 23, 2005 (JP) 2005-149100

(51) Int. Cl. B05D 5/12; B05D 3/02; B05D 5/00

(52) U.S. Cl. 427/58; 427/256; 427/372.2

(57) ABSTRACT

A method of forming a transparent conductive film on a substrate, comprises: forming a bank with a material including polysiloxane as a main component, wherein the bank corresponds to a region for forming the transparent conductive film; placing a first functional liquid including transparent conductive micro particles in a region partitioned by the bank by a liquid droplet discharging method; forming a first layered film by drying the first functional liquid; placing a second functional liquid including a metal compound on the first layered film by a liquid droplet discharging method; forming a transparent conductive layer composed of the first layered film and a metal oxide material, which is filled in holes formed in the first layered film, by burning the first layered film and the second functional liquid in a lump.

### BACKGROUND OF THE INVENTION

1. Technical Field

The present invention relates to a transparent conductive film, a method of forming thereof an electro optic device and an electronic apparatus.

2. Related Art

In a process of manufacturing an electro optic device such as a liquid display, a conductive transparent film made of indium tin oxide (ITO) and the like is formed as a pixel electrode when the pixel electrode is formed on a display side since it is necessary that light passes through the pixel electrode. In general, a gas phase method such sputtering or evaporation is used when a conductive transparent film made of indium tin oxide (ITO) and the like is formed.

In a gas phase method such sputtering, the film is generally patterned by a photolithographic method after the film was formed. This patterning by a photolithographic method, however, large scale facilities and complex processes are needed for forming films and etching them. Further, the efficiency of using material is only several percent and most of them are wasted, causing high manufacturing cost and low productivity.

On this background, a liquid phase method for forming a conductive transparent film is proposed. For example, it is known (see JPA 9-194233) that micro particles of ITO are dispersed into a resin and an organic solvent and the dispersed liquid is coated by a coating method or a printing method such as dip coating, spin coating, floating, screen printing, gravure printing and offset printing. Further, a coated film is dried and burned, forming a transparent conductive film. In this method, the film made of such micro particles of ITO has many holes. In order to avoid change of conductivity (specific resistance) due to incursion of gas and water into these holes, a metal oxide material is filled to these holes.

However, the following issues are raised when a transparent conductive film such as a pixel electrode is formed on the substrate in which thin film transistors made of amorphous silicon and others are formed by the above method.

In a coating method such as dip coating, spin coating and floating, a film made of mixture of ITO micro particles with metal oxide materials are formed n a entire surface, facing difficulty in micro dense patterning (etching.) Namely, there is no appropriate liquid that can etch such mixed film since an ITO film is usually wet-etched and patterned with a liquid such as hydrochloric acid and a silica oxide film as a metal oxide film is wet-etched and patterned with fluorinated acid.

Further, in a printing method such as screen, gravure and offset printings, it is difficult to form a metal oxide layer on the patterned ITO film with appropriately covering over the side surface of it. Hence, when a transparent conductive film (a transparent electrode) is formed by the above method, the conductivity (specific resistance) is changed due to absorption of humidity at the side surface of it. On the other hand, if a metal oxide layer is thickly formed in order to appropriately cover the side surface, the surface resistance of a transparent electrode becomes high and the transparency of it becomes lowered caused by the thicker metal oxide layer.

### SUMMARY

In view of the above issues, the present invention is to provide a conductive transparent electrode and a method of forming it that are capable of finely patterning a conductive transparent film and preventing such film from changing it's characteristics and lowering the transparency due to the effect of gas and water and to provide an electro optic device and an electronic device including such conductive transparent electrode.

According to an aspect of the invention, a method of forming a transparent conductive film on a substrate, comprises: forming a bank with a material including polysiloxane as a main component, wherein the bank corresponds to a region for forming the transparent conductive film; placing a first functional liquid including transparent conductive micro particles in a region partitioned by the bank by a droplet discharging method; forming a first layered film by drying the first functional liquid; placing a second functional liquid including a metal compound on the first layered film by a droplet discharging method; forming a transparent conductive layer composed of the first layered film and a metal oxide material, which is filled in holes formed in the first layered film, by burning the first layered film and the second functional liquid in a lump.

According to the method of forming a transparent conductive film, the first functional liquid and the second functional liquid are placed in order in the region partitioned by the bank by the droplet discharging method. This method can accurately form and pattern the transparent conductive film even such the film is densely patterned, if the bank is preliminarily formed corresponding to the intended pattern of the transparent conductive film.

Further, the transparent conductive film is formed within the bank, in particular, the side surface of the transparent conductive film is covered by the bank This structure can constrain the change of the conductivity of the transparent conductive film due to the absorption of humidity from the side surface without lowering its transparency.

Further, the bank is mainly made of polysiloxane, fairly improving the heat resistance of the bank comparing a bank made of an organic material, for example and making it possible to burn the first layered film and the second functional liquid in a lump with relatively high temperature.

Further, in the above method of forming the transparent conductive film, the first layered film and the second functional liquid may be burned in a lump under an inactive atmosphere or a reducing atmosphere.

This process makes it possible to provide a highly transparent conductive film with relatively low resistance.

Further, in the above method of forming the transparent conductive film, the first functional liquid may be dried under atmospheric air.

This process makes resin react with oxygen in an atmosphere, thermally decomposed and easily removed from the film if the resin is included in the first functional liquid.

Further, in the above method of forming the transparent conductive film, the bank may be formed by the following process. Namely, a photosensitive polysilazane liquid or a photosensitive polysiloxan liquid function as a positive photo resist, and including photooxidation product may be coated on the substrate, exposed, developed, patterned, and then burned.

This process secures better accuracy of pattering the bank since a photosensitive polysilazane liquid or a photosensitive polysiloxan liquid function as a positive photo resist.

Hence, the process also secures further accuracy of patterning transparent conductive films attained by the bank.

Further, in the above method of forming the transparent conductive film, the amount of the discharged second functional liquid may be adjusted so as to form a metal oxide layer made of the second functional liquid in the process of placing the second functional liquid on the first layered film. Here, the metal oxide layer is formed after burning the second functional liquid and the first layered film in a lump.

This process forms a metal oxide layer, which covers over the transparent conductive layer, avoiding the bad effect from gas and water.

Further, in the above method of forming the transparent conductive film, the second functional liquid may be placed on the first layered film by a droplet discharging method, so that a part of this functional droplet is discharged onto the bank when the second functional liquid is discharged in the vicinity of the bank. Further, the droplet may be placed within the region expressed by the following formula:(d/2)≦x<d, where “d” is the radius of the discharged droplet and “x” is the length toward the direction of radius of the droplet placed onto the bank.

This placement makes most half of droplets having radius d allocated on the bank, certainly drop on the edge of the first layered film contacting the bank and get there wet when these droplets fall down from the bank and stay on the first layered film. Accordingly, the second functional liquid is filled over the entire surface of the first layered film including the interface with the bank and the metal oxide material is filled into holes within the first layered film. Finally the transparent conductive layer is completed.

Further, in the above method of forming the transparent conductive film, a nitride silicon film may be preliminary formed on the substrate.

When thin film transistors are formed on a substrate, for example, a nitride silicon film may be preliminary formed as a gate insulating film and then a transparent conductive film may be formed on a entire surface of the nitride silicon film without pattering the film. This approach simplifies the manufacturing process.

In the process of manufacturing the transparent conductive film of the invention, the bank of which main material is polysiloxan is formed on a substrate and then a transparent conductive layer is formed. The transparent conductive layer includes the first layered film and the metal oxide material to be filled into holes within the first layered film.

This method can accurately form and pattern the transparent conductive film even such the film is densely patterned, if the bank is preliminarily formed corresponding to the intended pattern of the transparent conductive film since the transparent conductive film is formed within the region partitioned by a bank.

Further, the transparent conductive film is formed within the bank, in particular, the side surface of the transparent conductive film is covered by the bank. This structure can constrain the change of the conductivity of the transparent conductive film due to the absorption of humidity from the side surface without lowering its transparency.

Further, the bank is mainly made of polysiloxane, fairly improving the heat resistance of the bank comparing a bank made of an organic material, for example and making it possible to burn the first layered film and the second functional liquid in a lump with relatively high temperature. Accordingly, the transparent conductive film can be manufactured with high quality.

Further, in the transparent conductive film, the metal oxide layer may be formed on the transparent conductive film with covering over the transparent conductive layer.

This process forms the metal oxide layer, which covers over the transparent conductive layer, avoiding bad effects from gas and water.

According to an electro optic device of the invention, it is provided with the transparent conductive film formed by the above-mentioned process.

This electro optic device can display fine and accurate images since it is provided with fine and precise transparent conductive films. Further, the device can display stabilized images since the change of the conductivity of transparent conductive films is constrained without lowering its transparency.

An electronic apparatus according to the invention includes the above-mentioned electro optic device.

The electronic apparatus can display stabilized and refined images because of the above mentioned electro optic device.

### BRIEF DESCRIPTION OF THE DRAWINGS

The invention will be described with reference to the accompanying drawings, wherein like numbers reference like elements.

FIG. 1 is an equivalent circuit diagram of a liquid crystal display according to an embodiment of the invention.

FIG. 2 is a plane view of a overall structure of a display.

FIG. 3 is a plane view of a pixel region.

FIG. 4 is a sectional view of a part of a thin film transistors array substrate.

FIG. 5A shows an example of a droplet-discharging device and FIG. 5B is a schematic view of a discharging head.

FIGS. 6A to 6D are cross sectional process views showing a method of manufacturing thin film transistors.

FIGS. 7A to 7B are cross sectional process views showing a method of manufacturing thin film transistors.

FIGS. 8A to 8B are cross sectional process views showing a method of manufacturing thin film transistors.

FIGS. 9A to 9C are cross sectional process views showing a method of manufacturing thin film transistors.

FIG. 10 is a schematic view showing discharging and placing a functional liquid in the vicinity of a bank.

FIGS. 11A to 11D are cross sectional process views showing a method of manufacturing thin film transistors.

FIGS. 12A to 12D are cross sectional process views showing a method of manufacturing thin film transistors.

FIG. 13 is a perspective view of an example of an electronic apparatus.

### DESCRIPTION OF THE EXEMPLARY EMBODIMENTS

The embodiments of the invention are explained referring to figures. Here, in each of figures, contraction scales of layers and parts may be different so as to have recognizable size on each of figures.

Electro Optic Device

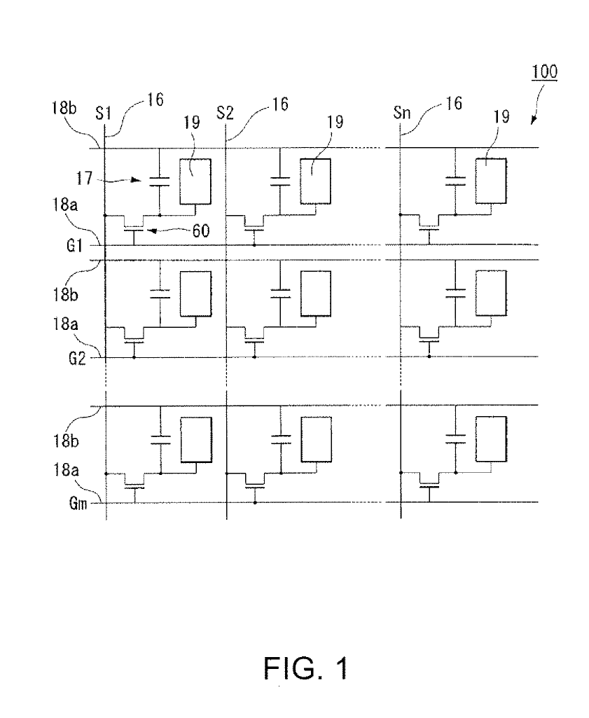

First, an embodiment of an electro optic device of the invention is explained. FIG. 1 is an equivalent circuit diagram of a liquid crystal display 100 according to an embodiment of the invention. The liquid crystal display 100 includes a plurality of dots arranged in a matrix for forming pixel regions. Each of these dots comprises a pixel electrode 19, a TFT 60 functioning as a switch element to control the pixel electrode 19 and data line 16 (an electrode line) to electrically connect the source of the TFT 60 as well as supply an image signal to it. Image signals S1, S2, . . . Sn are supplied to the data line 16 in this sequential orders. Otherwise, a group of these signals is supplied to plurality of data lines 16 adjacently located. Further, a scanning line 18a is electrically connected to the gate of the TFT 60. Scanning line pulse signals G1, G2 . . . Gm are supplied to a plurality of scanning lines in the sequential order with a predetermined time interval. Further, the pixel electrode 19 is electrically connected to the drain of the TFT 60. The TFT 60 as a switching element is turned on during a predetermined time, writing Image signals S1, S2, . . . Sn supplied from data lines 16 to pixel electrodes 19 with predetermined time interval.

Image signals S1, S2, . . . Sn having predetermined levels are written to a liquid crystal via the pixel electrode 19 and maintained between the pixel electrode 19 and a common electrode described hereafter. Accordingly, alignment and order of molecular group of a liquid crystal are changed corresponding to applied voltage level, modulating passing light and displaying appropriate gray scale. Further, each dot is provided with a storing capacitor 70, which is arranged in parallel with liquid crystal capacitance formed between the pixel electrode 10 and a common electrode. This capacitor avoids leak of image signals written to a liquid crystal. A capacitance line 18b is connected to one of electrodes of the storing capacitor 70.

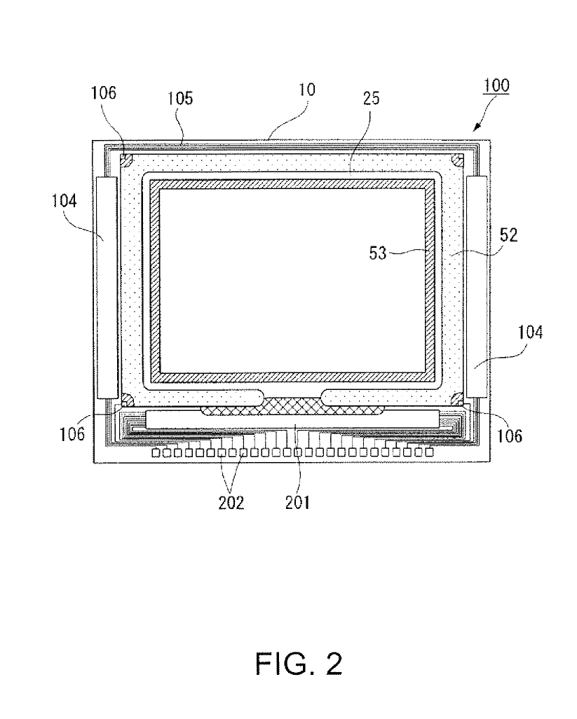

FIG. 2 is a plane view of a overall structure of the liquid crystal display 100. The liquid crystal display 100 mainly comprises a TFT array substrate 10, an opposing substrate 25 and a sealing member 52. The TFT array substrate 10 is attached to the opposing substrate 25 via the sealing member 52 and a liquid crystal is encapsulated by the sealing member 52 between these substrates 10 and 25. Here, in this figure, the outer circumference of the opposing substrate 25 is coincided with the circumference of the sealing member 52, seeing from a planar view.

Inside of the sealing member 52, a shielding member (as partitioning) 53 made of a light shielding material is formed as a rectangular shape. In the peripheral area outside of the sealing member 52, a data line driving circuit 201 and mounting terminal 202 are placed along the side of the TFT array substrate 10. A scanning line driving circuit 104 is placed along the other side perpendicular to the above side. A plurality of wirings 105 are placed on the further other side of the TFT array substrate 10 and connected to the scanning line driving circuits 104, 104. In the angular area of the opposing substrate 25, a plurality of conductive members between substrates 106 are placed to electrically connect the TFT array substrate 10 with the opposing substrate 25

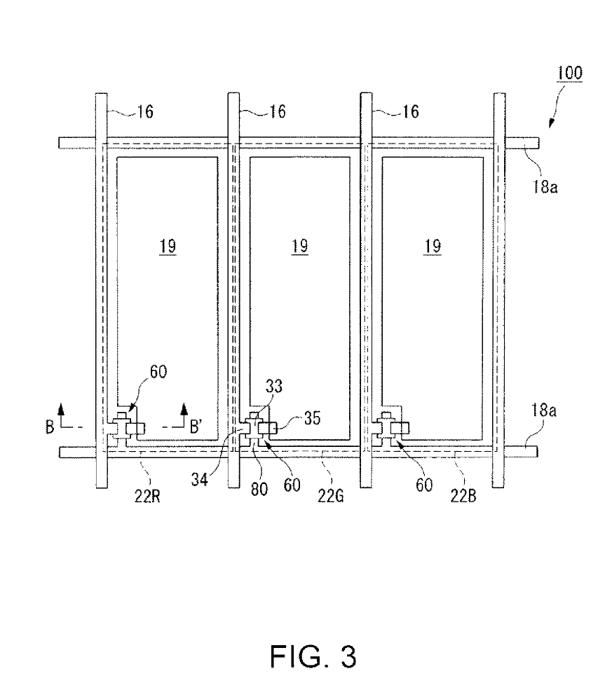

FIG. 3 is a schematical plane view of a pixel region of the liquid crystal display 100. As shown in FIG. 3, a plurality of scanning lines 18a and data lines 16 orthogonal to these scanning lines are elongated along one direction in a display region of the liquid crystal display 100. In FIG. 3, a dot region is a rectangular shape seeing from a plane view surrounded by the scanning line 18a and data line 16. A color filter for one of three primitive colors is formed in one dot region. Namely, three dot regions having three colored areas 22R, 22G and 22B form one pixel region. These three colored areas 22R, 22G and 22B are repeatedly arranged within a display area of the liquid crystal display 100.

In each dot shown in FIG. 3, the pixel electrode 19 made of a transparent conductive film such as indium tin oxide (ITO) is formed as a rectangular shape seeing from a plane view and the TFT 60 is formed among the pixel electrode 19, the scanning line 18a and the data line 16 The TFT 60 comprises a semiconductor layer 33, a gate electrode 80 formed on the lower side of the semiconductor layer 33(a substrate side), a source electrode 34 formed on the upper side of the semiconductor layer and a drain electrode 35. A channel region of the TFT 60 is formed in a region where the semiconductor layer 33 opposes the gate electrode 80 and source and drain regions are formed on both sides of the semiconductor layer.

The gate electrode 80 is separated into the two directions of a part of the scanning line 18a, as well as being elongated toward the data line 16. At the end, the gate 80 is opposed to the semiconductor layer 33 along the perpendicular direction toward the paper plane via an insulating film (a gate insulating film.) The source electrode 34 is separated into the two directions of a part of the data line 16, as well as being elongated toward the scanning line 18a. The source electrode 34 is electrically connected to the semiconductor layer 33 (a source region.) The one end (the left side in the figure) of the drain electrode 35 is electrically connected to the semiconductor layer 33 (a drain region) and the other end (the right side in the figure) of it is electrically connected to the pixel electrode 19.

In the above structure, the TFT 60 is turned on by the gate signal input via the scanning line 18a during a predetermined time interval, functioning as a switching element. The switching element writes image signals supplied via the data line 16 into a liquid crystal with the predetermined time interval.

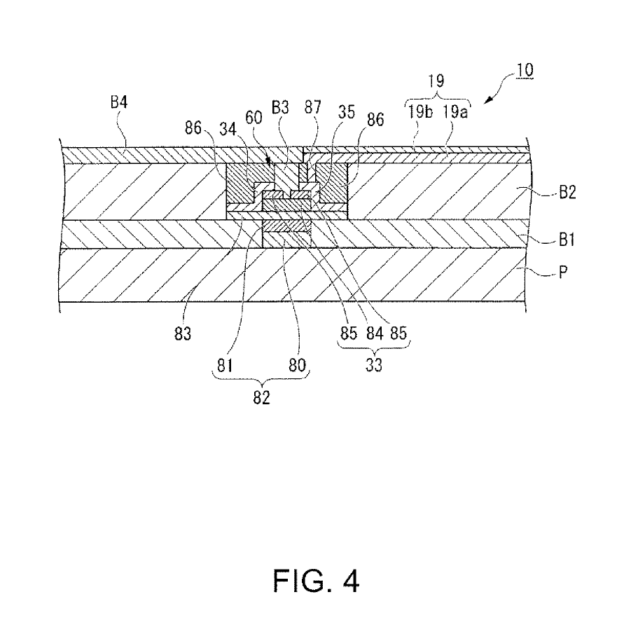

FIG. 4 is a sectional view of a main part of the thin film transistors array substrate 10, along with the line B-B′ shown in FIG. 3. As shown in FIG. 4, in the thin film transistors array substrate 10, the TFT 60 is formed inside of the glass substrate P (the upper side of it in the figure) and the pixel electrode 19 of the invention is further formed. A first bank B1 of which a part is opened is formed on the substrate P and the gate electrode 80 and the cap layer 81 covering over the electrode 80 are formed in the opening of the bank B1. The gate electrode layer 80 is made of metal such as Ag, Cu and Al, which is formed over the glass substrate P. The cap layer 81 covers over the gate electrode layer 80, preventing metal material of the electrode from diffusing. The cap layer is formed by depositing metal layers such as Ni, Ti, W and Mn over the gate electrode 80.

A second bank B2 is formed on the first bank B1. In the second bank B2, an opening is formed to expose the region including the gate electrode 80 and the cap layer 81. Within this opening, the gate insulating film 83 made of silica oxide and silicon nitride is formed. The semiconductor layer 33 is formed on the gate insulating layer 83 and overlapped with the gate electrode 80. The semiconductor layer 33 comprises an amorphous silicon layer 84 and a N⁺ silicon layer 85 formed on the amorphous silicon layer 84. The N⁺ silicon layer 85 is divided into two regions, which are coplanar and separated each other on the amorphous silicon layer 84. One region of the N⁺ silicon layer 85 is electrically connected to the source electrode 34 formed on both the gate insulating film 83 and the N⁺ silicon layer 85. Another region of N⁺ silicon layer 85 is electrically connected to the drain electrode 30 formed on both the gate insulating film 83 and the N⁺ silicon layer 85.

The source electrode 34 is separated from the drain electrode 35 by a third bank B3 formed within the opening of the second bank B2. These electrodes are formed by a droplet discharging method described later within the region partitioned by the second bank B2 and the third bank B3 as described later. A insulating material 80 filled in the opening is placed on the source electrode 34 and the drain electrode 35. Further, the pixel electrode 19 is formed within the region partitioned by a fourth bank 4 on the second bank B2 and the insulating material 86. The pixel electrode 19 is an embodiment of the transparent conductive film of the invention, which comprises a transparent conductive layer 19a and a nitride oxide layer 19b covering over the transparent conductive layer 19a. The transparent conductive layer 19a comprises the first layered film made of transparent conductive particles described later and a nitride oxide material filled in holes of the first layered film. Further, the pixel electrode 19 is connected to the drain electrode 35 via a contact hole 87 formed in the insulating material 86. Finally the TFT 60 is formed based on the above structured elements.

Here, as shown in FIG. 3, the data line 16 and source electrode 34 are integrally formed and the scanning line 18a and the gate electrode 80 are also integrally formed. Therefore, the data line 16 is covered by the insulating material 86 and the scanning line 18a is covered by the cap layer 81 as well as the gate electrode layer 80

In actual, an alignment layer is formed on the surface of the pixel electrode 19 and the fourth bank B4 to control the initial alignment of a liquid crystal. A phase difference plate and a polarization plate are formed on the outside of the glass plate P to control the polarization of light. Further, in a case of a transparent or semitransparent liquid display, a backlight is installed on the outside of the TFT array substrate (the backside of the panel) 10 to irradiate the panel.

The opposing substrate 25 is provided with color filter layers and a opposing electrode on the inside of the substrate similarly to the glass substrate P (the surface opposing the TFT array substrate.) Color filters comprise arranged color areas 22R, 22G and 22B and the opposing electrode is composed of a transparent conductive film having a solid plane. Further, the alignment layer is formed of the opposing electrode similarly to the TFT array substrate. A phase difference plate and a polarization plate are formed on the outside of the substrate if they are necessary.

Further, liquid crystal molecules are encapsulated as a liquid crystal layer sealed within a space between the TFT array substrate 10 and the opposing substrate 25. As liquid crystal molecules constituting the liquid crystal layer, any liquid crystal molecules are used if they are aligned such as nematic or smectic liquid crystal molecules. In case of a TN type liquid crystal panel, a nematic liquid crystal is preferable. Phenylcyclohexane derivative liquid crystal, biphenyl derivative liquid crystal, biphenylcyclohexane derivative liquid crystal, terphenyl derivative liquid crystal, phenylether derivative liquid crystal, phenylester derivative liquid crystal, bicyclohexane derivative liquid crystal, azomethine derivative liquid crystal, azoxy derivative liquid crystal, pyrimidine derivative liquid crystal dioxane derivative liquid crystal, cubane derivative liquid crystal are cited as the nematic liquid crystal.

According to the embodiment constituting the above mentioned structure, the liquid crystal display 100 displays gray scale images by applying voltages that modulate the alignment state of a liquid crystal layer. Further, the display shows appropriate color images by mixing three primitive colors (R, G, and B) every pixel since each dot is provided with color areas 22R, 22G and 22B.

Method of Manufacturing Thin Film Transistors

Next, an embodiment of the method of manufacturing a transparent conductive film of the invention is described as well as a method of manufacturing the TFT 60 and a pixel electrode connected to it. In the TFT 60, the gate electrode 80, the source electrode 34, the drain electrode 35 and the pixel electrode 19 are formed and patterned by a droplet discharging method with using a bank.

Droplet-Discharging Device

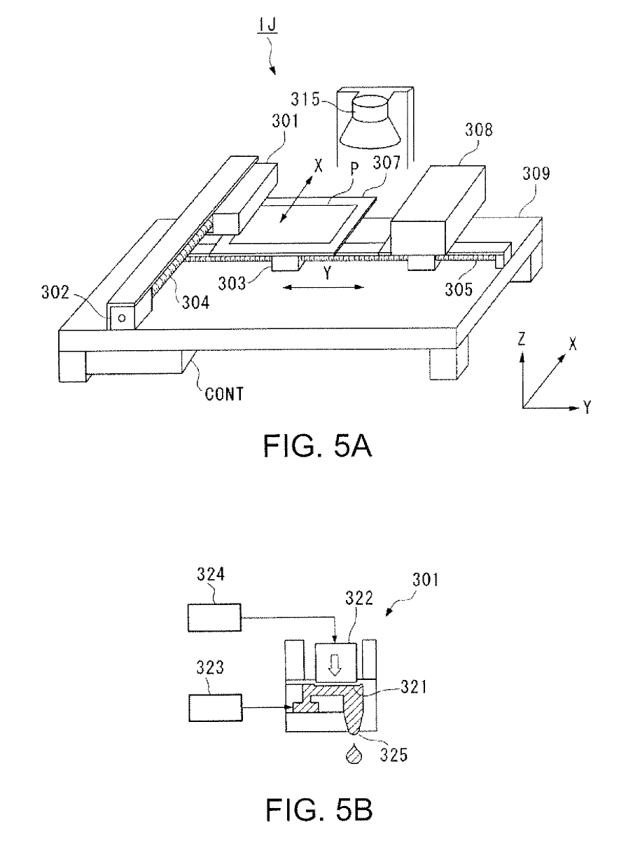

First, a droplet-discharging device, which is used in the embodiment of the manufacturing method is explained. In the manufacturing method, ink (functional liquids) such as conductive micro particles or other functional materials are discharged as droplets from a nozzle of a droplet discharging head of the droplet-discharging device so as to form any elements constituting a thin film transistor. FIGS. 5A and 5B show the droplet-discharging device which is used in the embodiment.

FIG. 5A is a perspective view showing a droplet-discharging device IJ, which is used in the embodiment.

The droplet-discharging device IJ comprises a droplet discharging head 301, a driving shaft for the X-axis direction 304, a guiding shaft for the Y-axis direction 305, a controller CONT, a stage 307, a cleaning mechanism 308, a base 309 and a heater 314.

The stage 307 supports the substrate P, which receives ink (functional liquids) from the droplet-discharging device IJ and includes a fixing mechanism (not shown in the figure) to fix the substrate P to the reference position

The droplet discharging head 301 is provided with a plurality of discharging nozzles as a multiple-nozzles type and its longitudinal direction is coincided with the Y-axis direction. A plurality of discharging nozzles is arranged with a predetermined interval along the Y-axis direction at the lower surface of the droplet discharging head 301. The Ink (functional liquids) is discharged to the substrate P supported by the stage 307 from the discharging nozzle of the droplet discharging head 301.

The driving shaft for the X-axis direction 304 is coupled to a driving motor for the X-axis direction 302. The driving motor for the X-axis direction 302 is a stepping motor and the like that drives the driving shaft for the X-axis direction 304 when a driving signal for the X-axis direction is supplied from the controller CONT. When the driving shaft for the X-axis direction 304 rotates, the droplet discharging head 301 moves to the X-axis direction.

The guiding shaft for the Y-axis direction 305 is fixed without moving relatively to the base 309. The stage 307 is provided with a motor for the Y-axis direction 303. The driving motor for the Y-axis direction 303 is a stepping motor and the like that moves the stage 307 toward the Y direction when a driving signal for the Y-axis direction is supplied from the controller CONT.

The controller CONT supplies voltages to the droplet discharging head 301 to control discharging of droplets. Further the controller supplies a driving pulse signal to the driving motor for the X-axis 302. This driving pulse signal controls the movement of the droplet discharging head 301 toward the X-axis direction. The controller also supplies a driving pulse signal to the driving motor for the Y axis 303. This driving pulse signal controls the movement of the stage 307 toward the Y-axis direction.

The cleaning mechanism 308 cleans the droplet discharging head 301. The cleaning mechanism 308 is provided with a driving motor for the Y-axis direction not shown in the figure. The driving motor for the Y-axis direction moves the cleaning mechanism 308 along the guiding shaft for the Y-axis direction 305. The movement of the cleaning mechanism 308 is controlled by the controller CONT.

The heater 315 is a unit to heat the substrate P with lamp annealing, which evaporates and dries a solvent included in a solution coated on the substrate P. The controller CONT controls turning the power source of the heater 315 on and off.

The droplet-discharging device IJ discharges droplets onto the substrate P with relatively scanning the droplet discharging head 301 and the stage 307, which supports the substrate P. Here, the X-axis direction is defined as a scanning direction and the Y-axis direction orthogonal to the X-axis direction is defined as a non scanning direction, hereafter. Namely, discharging nozzles of the droplet discharging head 301 are arranged with a predetermined interval along the Y-axis direction as the non-scanning direction. Here, in FIG. 5A, the droplet discharging head 301 is arranged perpendicularly to the moving direction of the substrate P. But, the head may be crossed toward the moving direction of the substrate P by arranging the angle of droplet discharging head 301. This arrangement adjusts pitches among nozzles by adjusting the angle of droplet discharging head 301. The distance between the substrate P and the nozzle surface may be arbitrarily adjusted.

FIG. 5B is a schematic view of a droplet discharging head to explain the principle of discharging ink based on a piezo method.

In FIG. 5B, a piezo element 22 is placed adjacent to a liquid chamber 321 that stores ink (functional liquids.) Ink is supplied to the liquid chamber 321 via a ink supplying system 323 including a material tank storing ink. The piezo element 322 is coupled to a driving circuit 324. The driving circuit 324 applies voltages to the piezo element 322, deforming the piezo element 322 to elastically deform the chamber 321. Then, a liquid material is discharged from a nozzle 325 by changing the volume of the chamber when it is elastically deformed.

In this case, the amount of the distortion of the piezo element 322 is controlled by changing the values of applied voltages. In this case, the speed of the distortion of the piezo element 322 is controlled by changing the frequency of applied voltages. A droplet discharging method with a piezo method has advantage where bad effects are not applied to material compositions since materials are not heated.

Ink (Functional Liquid)

Here, ink (a functional liquid) used for a conductive pattern such as the gate electrode 80, the source electrode 34 and the drain electrode 35 in the manufacturing method of the embodiment is explained.

Ink (a functional liquid) used for the conductive pattern in the embodiment is made of conductive micro particles dispersed into a dispersion media or it's precursor. As conductive micro particles, metal micro particles such as gold, silver, copper, palladium, aluminum, titan, tungsten, manganese, niobium, and nickel, or these precursors, these alloys or these oxide and transparent conductive micro particles such as a conductive polymer and indium tin oxide are used.

In particular, when a transparent conductive film such as pixel electrode 19 described later is formed, transparent conductive micro particles such as indium tin oxide, indium zinc oxide, or oxide composed of indium, tin, and zinc are used.

An organic material may be coated over the surface of these conductive micro particles including transparent conductive micro particles in order to improve dispersion. The diameter of a conductive fine particle is favorably more than 1 nm and under 0.1 micron. If the diameter is larger than 0.1 micron, particles may clog the nozzle of the droplet discharging head 301 and deteriorates high density of a obtained film. On the other hand, when the size is less than 1 nm, the volume ratio of coating material to the conductive micro particles becomes large and the ratio of organic material in the obtained film becomes too munch.

A solvent is not specifically limited if it can disperse the conductive micro particles and does not make particles aggregate. Such dispersion medium and/or solvents are water, alcohol such as methanol, ethanol, propanol, butanol, carbon hydride compound such as n-heptanes, n-octane, decane, toluene, xylene, cymene durren, inden, dipenten, tetrahydro naphthalene, decahydro naphthalene and cyclohexyl benzen and eter compound such as ethleneglycol dimethyl eter, ethleneglycol diethyl eter, ethleneglycol methyl ethyl eter, diethleneglycol dimethyl ethyl eter, diethleneglycol diethyl eter, diethleneglycol methyl ethyl eter, 1,2-di methoxy ethane, bis(2-methoxy ethyl) eter, and p-dioxane and a polar compound such as propylene carbonate, γbutyrolactone, N-methyl-2 pyrrolidone, dimethyl formamide, dimethyl sulfoxide, cyclo hexanoate. Water, alcohol, carbon hydride compound and ether compound among them are preferable in view of dispersion of micro particles, stable solution, easy soluble organic metal, and appropriate for applying to a droplet discharging method. In particular, water and carbon hydride compound are further preferable as a dispersion medium or solvent.

The surface tension of the solution including conductive micro particles is preferably in the range of 0.02N/m to 0.07 N/m. If the surface tension is less than 0.02N/m, droplets easily veeringly fly when droplets are discharged by an inkjet method since the wettablity of ink compounds to the nozzle surface increases. On the other hand, if the surface tension is more than 0.07N/m, it become difficult to control the amount of discharging and timing of it since the configuration of meniscus becomes unstable at the nozzle edge. In order to arrange the surface tension, a small amount of materials for arranging the surface tension such as fluorine, silicon, nonion may be added to a liquid material as well as avoiding decreasing contact angle with the surface of the substrate. A nonion group material for arranging the surface tension improves the wettability of the liquid material to the substrate and the leveling property of the film, preventing the coated film from having fine uneven surfaces. Materials for arranging the surface tension may include organic compounds such as alcohol, ether, ester and ketene if they are necessary.

The viscosity of the solution is preferably more than 1 mPa·s and less than 50 mPas. If the viscosity of the solution is less than 1 mPa·s, the peripheral of the nozzle is easily contaminated with a flowed ink when a liquid material is discharged as droplets by a inkjet method. On the other hand, if the viscosity of the solution is more than 50 mPa·s, the nozzle hole is easily clogged, making it difficult to smoothly discharge droplets and reducing amount of discharging droplets.

Further, when forming the first bank B1, the second bank B2, the third bank B3, and the fourth bank B4, there is no specific limitation. But, materials for forming them are a polysilazane liquid and a polysiloxan liquid. The polysilazane liquid is more preferable. The polysilazane liquid is mainly composed of polysilazane. A photosensitive polysilazane liquid including polysilazane and photooxidation product is used as the polysilazane liquid for example. The photosensitive polysilazane liquid functions as a positive resist, which is directly patterned by exposure and development processes. JPA 2002-72504 discloses examples of the photosensitive polysilazane. Further, JPA 2002-72504 also discloses examples of the photooxidation product included in the photosensitive polysilazane.

A part of this polysilazane is hydrolyzed by humidification as shown in the following formula (2) or (3) if the polysilazane is polymethylsilazane for example as shown in the following formula (1). Further, this hydrolyzed polysilazane becomes polymethylsiloxane [—(SiCH₃O _{1.5})n-] with condensation as shown in the following formulas (4) to (6) by heating under 3500° C. If it is heated with more than 350° C., the side chain, methyl is removed. More particularly, if it is heated with 400° C. to 450° C., it becomes polysiloxane by removing the side chain, methyl. In the following formulas (2) to (6), only basic element units (repeated units) are shown by simplifying chemical formulas in order to explain reaction mechanisms.

These polymethylsiloxane and polysiloxane formed by the above method are based on polysiloxane, which is an inorganic material, showing sufficient density comparing with a metal layer formed by a droplet discharging method and burning, for example. Hence, the flatness of the surface of a formed layer (film) is preferably attained. Further, these have high resistance against heating, being preferable materials for a bank.
—(SiCH₃(NH)_{1.5})n- Formula (1)
SiCH₃(NH)_{1.5};+H₂O→SiCH₃(NH)(OH)+0.5NH₃ Formula (2)
SiCH₃(NH)_{1.5};+2H2O→SiCH₃(NH)_{0.5}(OH)₂+NH₃ Formula (3)
SiCH_{3(NH)(OH)+SiCH3}(NH)(OH)+H₂O→2SiCH₃O_{1.5}+2NH₃ Formula (4)
SiCH₃(NH)(OH)+SiCH₃(NH)_{0.5}(OH)₂→2SiCH₃O_{1.5}+1.5NH₃ Formula (5)
SiCH₃(NH)_{0.5}(OH)₂+SiCH₃(NH)_{0.5}→2SiCH₃O_{1.5}+2NH₃H₂O Formula (6)

Furthers in the invention, when forming the first bank B1, the second bank B2, the third bank B3, and the fourth bank B4, the polysilazane liquid is not necessarily used. But, polysiloxane (photosensitive polysiloxane) can be used instead. Further, when a bank does not correspond to a region for forming a transparent conductive film of the invention, a well known organic resist can be used. Forming materials may be differentiated according to banks. Namely, a part of banks may be formed by the polysilazane liquid and the rest of them may be formed by organic resists.

Method of Manufacturing TFT Array Substrate

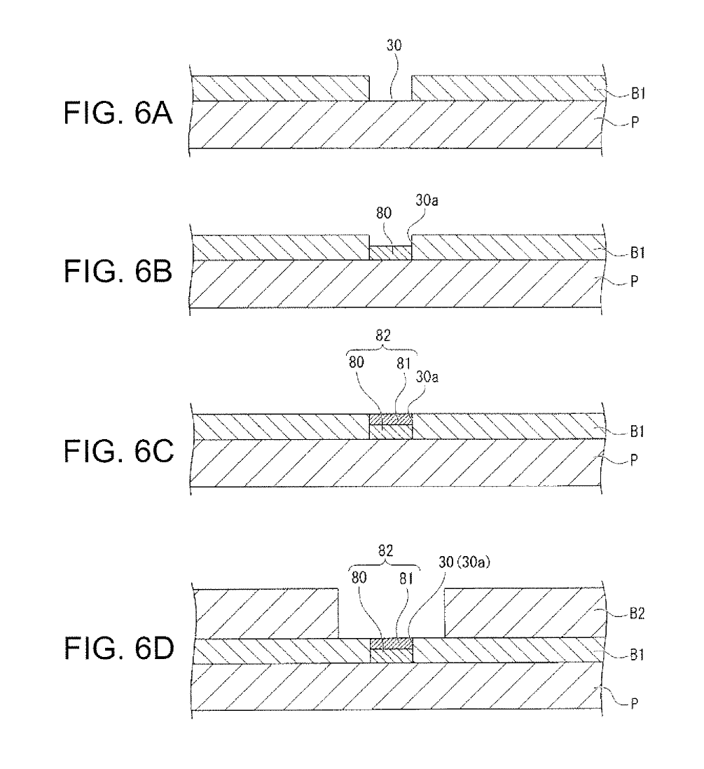

The method of manufacturing a TFT array substrate including the method of manufacturing TFT 60 is explained referring with FIG. 6 to FIG. 9. FIGS. 6 to. 9 are cross sectional sequential processes of manufacturing in the embodiment.

Forming Electrode

As shown in each of FIGS. 6A to 6D, the first bank B1 is formed on the one surface of the prepared glass substrate P made of non-alkali glass. Then, a predetermined amount of ink (a functional liquid) is discharged into the opening 30 formed in the bank B1 so as to form the gate electrode 80 within the opening 30. The process of forming gate electrode comprises forming a bank, lyophobic processing, forming the first electrode layer, forming the second electrode layer, and burning.

Forming First Bank

First, as shown in FIG. 6A, the first bank B1 including opening 30, a predetermined pattern is formed on the glass substrate P in order to form the glass electrode 80 (and the scanning line 18a) as a predetermined pattern on the glass substrate. The bank B1 is a partitioning member zoning the substrate in a plane surface and formed by a photolithography, a printing method and other arbitrary methods. If a photolithography is used, a photosensitive material layer is formed by coating an organic photosensitive material such as acryl resin with adjusting the height, which is the same of a bank formed on the glass substrate P. Such coating is selected from spin coating, spray coating, roll coating, die coating and dip coating. Then, the first bank B1, which is provided with the opening 30 for the gate electrode, is finally formed by irradiating UV light to the photosensitive layer with adjusting the irradiated area along with a bank configuration.

When forming the first bank B1, the abovementioned photosensitive polysilazane liquid may be used. Namely, it is coated by a spin coating and the like, exposed, developed and burned in order to form the bank. Otherwise, polysilazane liquid may be selectively discharged by a droplet discharging method and burned so as to be directly patterned.

Lyophobic Process

Next, the surface property of first bank B1 is modified into lyophobic by the lyophobic process. As the lyophobic process, tetrafluoromethane is used for example as a processing gas with a plasma processing (CF₄ plasma processing) under atmospheric air The conditions for plasmatizing CF₄ gas are the plasma power: 50 Kw to 1000 Kw, the amount of CF₄ gas:50 ml/min. to 100 ml/min., the speed of transferring a substrate relatively to a plasma discharging electrode 0.5 mm/sec to 100 mm/sec and the substrate temperature: 70° C. to 90° C. As a processing gas, other fluoroacarbon gases may be used instead of tetrafluoromethane.

The fluorine base is introduced to the alkyl base constituting the first bank B1 by this lyophobic process, modifying the surface property of the first bank B1 into highly lyophobic.

Further, before lyophibic processing, ashing is preferably implemented to the glass substrate P exposed on the bottom of the opening 30 with O2 plasma UV or UV light is irradiated to it to be cleaned. This processing removes residue of a bank on the surface of the glass substrate P, and make the difference between the contact angle of the first bank B1 and the contact angle of the substrate surface become large. Further, it accurately puts the droplets discharged into the opening 30 into the inside of the opening 30 as later process. If the first bank B1 is acryl resin or polyimide reason, it is easily fluorinated (becomes lyophibic) when it is exposed to O₂ plasma before plasma processing with CF₄. Hence, O2 ashing process is preferably implemented before plasma processing with CF₄ if the first bank is made of these materials.

The O2 ashing process is implemented by irradiating plasmatized oxygen onto the glass substrate P from the plasma discharging electrode. The conditions for processing are the plasma power: 50 Kw to 1000 Kw, the amount of oxygen gas:50 ml/min. to 100 ml/min., the speed of transferring the substrate P relatively to a plasma discharging electrode 0.510 mm/sec to 10 mm/sec and the substrate temperature: 70° C. to 90° C.

Here, the lyophibic processing to the first bank B1 (plasma processing with CF₄) somewhat affects the substrate P, which became lyophilic at the time of residue processing. However, the lyophilic property of the substrate P, namely the wettablity of it is not substantially deteriorated since the substate P is made of a glass, making it uneasy that the fluorine base is introduced by the lyophibic processing. Further, the lyophibic processing may be omitted if the first bank B1 is formed with a material (such as a resin material having the fluorine base) having a lyophibic property.

Forming Gate Electrode Layer

Next, ink (not shown) is discharged to the opening 30 from the droplet discharging head 301 of the droplet-discharging device IJ in order to form the gate electrode layer. Here, ink comprises silver (Ag) as conductive micro particles and diethylene glycol diethyl ether as a solvent (a dispersion medium). The surface property of the first bank has already been lyophibic at this discharging, and the substrate surface of the bottom of the opening 30 has already been lyophilic, making a part of droplets slip into the inside of opening 30 with being repelled from the surface of a bank even if such part of droplets is placed on the first bank B1.

Next, after discharging ink droplets for forming electrodes, a solvent is removed by drying if it is necessary. Drying process is implemented by heating the substrate P with a hotplate or an electric oven. In the embodiment, it takes 60 minutes to heat the substrate with 180° C. It is not necessarily heated under atmospheric air, but under the nitrogen atmosphere and others.

The drying process may be implemented with lamp annealing. A light source is not specifically limited. A infrared lump, a xenon lamp, a YAG laser, a Argon laser, a carbon dioxide gas laser and a excimer laser such as XeF, XeCl, XeBr, KrF,KrCl,ArF,ArCl are used as a light source. These light sources generally have an output power in the range of 10 W to 5000 W. In this embodiment, the power of 100 W to 1000 W is sufficiently used. This intermediate drying forms the solid gate electrode layer 80 as shown in FIG. 6B.

Forming Cap Layer

Next, ink (not shown) is discharged to the opening 30 of the first bank B1 by using a droplet-discharging device to form a cap layer (not shown.) Here, ink (a liquid material) comprises nickel (Ni) as conductive micro particles and water and diethanolamine as a solvent (a dispersion medium). The surface property of the first bank B1 has already been lyophibic at this discharging, making a part of droplets slip into the inside of opening 30 with being repelled from the surface of a bank even if such part of discharged droplets is placed on the first bank B1. But, the surface of the first electrode layer 80a already formed within the opening 30 is not necessarily lyophilic to this discharged ink. Hence, an intermediate layer may be formed on the gate electrode layer 80 before discharging droplets in order to improve the wettablility of ink. This intermediate layer is arbitrary selected depending on kinds of solvents constituting ink. In case of using a water solvent in ink in the embodiment, using titan oxide for this intermediate layer attains preferable wettablility on the surface of the intermediate layer.

Next, after discharging ink droplets for forming electrodes, a solvent is removed by drying if it is necessary. Drying process is implemented by heating the substrate P with a hotplate or an electric oven. The conditions for processing are heating time: 60 minutes and heating temperature: 180° C. It is not necessarily heated under atmospheric air, but under the nitrogen atmosphere and others.

The drying process may be implemented with lamp annealing. The light sources which were used in the intermediate drying process after forming the first electrode layer are also used for this lamp annealing. The power for heating are also in the range of 100 W to 1000 W. This intermediate drying forms the cap layer 81 on the solid gate electrode layer 80 as shown in FIG. 6C.

Burning Process

It is necessary to perfectly remove a dispersion medium from the dried film after discharging process in order to improve the electrical contact among conductive micro particles. Further, it is necessary to remove a coating material such as inorganic, which is used for improving dispersion capability in a liquid, if the coating material is coated on the surface of the conductive micro particles. Hence, the substrate after the discharging process is heated and/or irradiated with light.

This thermal treatment and/or optical treatment are implemented in a atmospheric air. But, it can be implemented in the inactive gas atmosphere such as nitrogen, argon, helium if it is necessary. The temperature for thermal treatment and/or optical treatment is appropriately determined in considering kinds of atmospheric gases, pressures, thermal behavior such as dispersion and oxidization capability of micro particles, an amount of a coating material, resistance temperature of a substrate. Such temperature can be under 250° C. since the first electrode layer 80a and the second electrode layer 80b are made of the above mentioned materials.

In this process, a semiconductor layer is still not formed on the substrate, increasing the burning temperature within the range of heat resistance temperature of the first bank B1. Such burning temperature is over 250° C. or 300° C., forming a metal wiring provided with preferable conductivity. Specifically, when the first bank B1 composed of inorganic layer of which main material is polysiloxane, is formed with using polysilazane, the burning temperature is more than 250° C.

These above mentioned processes changes the dried film after discharging to a conductive film with securing electrical contact among micro particles. As shown in FIG. 6C, a conductive pattern 82 comprising the gate electrode 80 and the cap layer 81 is formed. Further, as shown in FIG. 3, the scanning line 18a integrated with the gate electrode 80 is also formed on the glass substrate.

In the above-mentioned process, the gate electrode 80a made of Ag and the cap layer 80b made of Ni are formed and the conductive pattern 82 is formed as a multi layered film comprising these electrode 80a and the cap layer 80b. But, the gate electrode 80a may be made of metal except Ag such as Cu and Al or alloy mainly including these metals. Further, the cap layer 81 may be made of metal except Ni such as Ti, W and Mn or alloy mainly including these metals. Further, Mn or Ti, ro W functioning as a dense layer may be deposited as a first layer and Cu or Al functioning as a main conductive layer may be deposited as a second layer. Otherwise, the conductive pattern 82 functioning as a gate electrode may be formed by depositing more than three electrode layers or a single electrode layer.

Forming Second Bank

Next, the ink (a polysilazane liquid) is discharged to a predetermined position on the first bank B1 from the droplet discharging head 301. Here, the ink made of the PL liquid is mainly composed of the above-mentioned PL. Further, the predetermined position on the first bank B1 is a position, which partitions the region for forming the source electrode 34 and drain electrode 35 and a region for forming the second bank B2. Here, the PL liquid can be selectively coated to a desired position by the sequential processing since the PL liquid is discharged to the predetermined position by the droplet discharging head 31

Thus, after the PL liquid is placed, the obtained PL thin film is preliminary baked with 110° C. and one minute on a hot plate if it is necessary.

Next, the film is burned with 110° C. and sixty minutes so as to form the second bank B2 as shown in the FIG. 6D. Here, the film may be exposed to light and humidified before burning when a photo sensitive PL liquid including PL and PX is used as the ink of the PL liquid. These processes make it possible to easily change PL shown in the formula (1) to PM shown in the formulas (4) to (6). Accordingly the second bank B2 formed by these processes is mainly made of PM as an inorganic material, showing fairly superior heat resistance comparing with a bank made of an organic material.

Forming Gate Insulating Layer

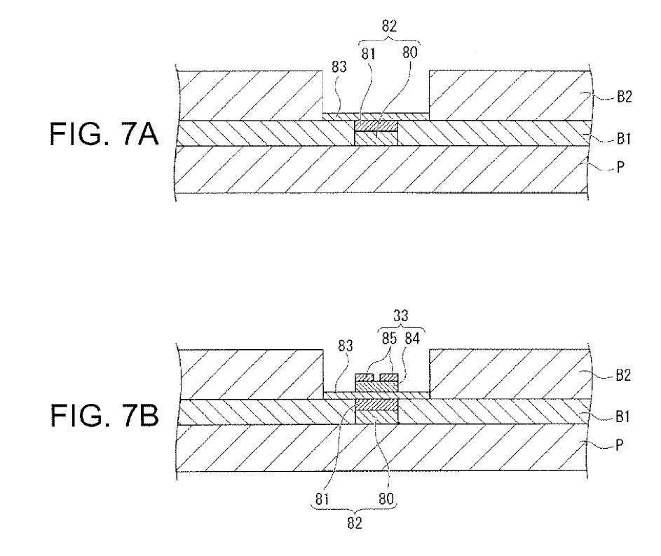

Next, a gate insulating film 83, which is made of nitride silicon, is formed in the region partitioned by the second bank B2 as shown in FIG. 7A. In order to form the gate insulating film 83, nitride silicon is deposited over the entire surface of the substrate by a CVD method for example and then appropriately pattered by a photolithography method. Material gases for the CVD process are preferably a mixed gas of silane and nitric monoxide, tetraethoxysilan: Si(OC₂H₅)₄} (TEOS) and oxygen, and disilane and ammonia. The thickness of the gate insulating film 83 is 150 nm to 400 nm. The nitride silicon film is not necessarily patterned. The nitride silicon film may stay on the bank B2.

Forming Semiconductor Layer

Next, a semiconductor layer 33 is formed over the gate insulating film 83 as shown in FIG. 713. In order to form the semiconductor layer 33, an amorphous silicon film of which thick thickness is 150 nm to 250 nm and a N⁺ silicon film of which thick thickness is 50 nm to 100 nm are sequentially deposited and patterned to a predetermined configuration by a photolithographic method. Material gases for manufacturing the amorphous silicon film are preferably disilane and monosilan. As the following process, a N⁺ silicon film is formed with introducing a material gas for forming a N⁺ silicon layer by a forming apparatus, which was used in previously forming the amorphous silicon film.

Then, the amorphous silicon film and the N⁺ silicon film are patterned as the configuration shown in FIG. 7B by a photolithographic method, forming the semiconductor layer 33 on the gate insulating film 83 in which the amorphous silicon layer 84 and the N⁺ silicon layer 85 are sequentially deposited. Regarding patterning, a photo resist having the concave shape, which is similar to the configuration of the side surface of the semiconductor layer 33 shown in the figure, is selectively placed over the N⁺ silicon layer and the layer is etched with being masked by the resist. Accordingly, the N⁺ silicon layer 85 is selectively removed and divided into two regions at the region where it is overlapped with the gate electrode layer 80 by the abovementioned patterning method, forming a source contact region and a drain contact region.

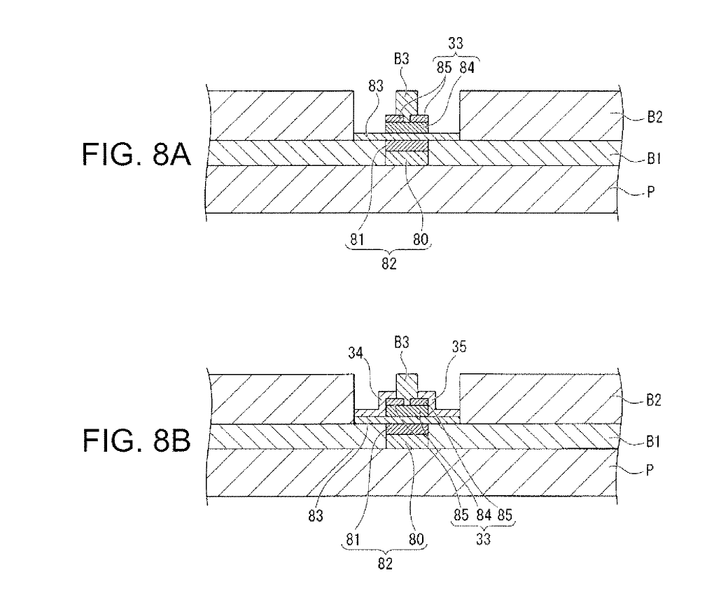

Next, as shown in FIG. 8A, the third bank B3 made of an insulating material is formed on the N⁺ silicon layer 85 which is divided into the two regions, electrically insulating these two regions 85 an 85. The third bank B3 is formed by selectively discharging and placing the PL liquid ink from the droplet discharging head 301, drying and burning it, which is similar to the bank B2. Accordingly, the bank B3 formed by these processes partitions regions for forming both the source electrode 34 and the drain electrode 35.

Forming Electrode

Next, as shown in FIG. 4, the source electrode 34 and the drain electrode 35 are formed on the glass substrate P on which the semiconductor layer 33 is formed.

Lyophobic Process

Next, the surface property of the second bank B2 and the third bank B3 is modified into lyophobic by the lyophobic process. As the lyophobic process, tetrafluoromethane is used for example as a processing gas with plasma processing (CF₄ plasma processing) under atmospheric air

Forming Electrode Film

Next, in order to form the source electrode 34 and the drain electrode 35 shown in FIG. 4, functional liquid ink is coated in the region surrounded by the second bank B2 and the third bank B3 by using the droplet-discharging device IJ. Here, ink comprises silver as conductive micro particles and diethylene glycol diethyl ether as a solvent (a dispersion medium). Next, after discharging ink droplets for forming electrodes, a solvent is removed by drying if it is necessary. Drying process is implemented by heating the substrate P with a hotplate or an electric oven. In the embodiment, it takes 60 minutes to heat the substrate with 180° C. It is not necessarily heated under atmospheric air, but under the nitrogen atmosphere and others.

The drying process may be implemented with lamp annealing. The light sources, which were used in the intermediate drying process after forming the first electrode layer are also used for this lamp annealing. The power for heating are also in the range of 100 W to 1000 W.

Burning Process

It is necessary to perfectly remove a dispersion medium from the dried film after discharging process in order to improve the electrical contact among conductive micro particles. Further, it is necessary to remove a coating material such as an organic material, which is used for improving dispersion capability in a liquid, if the coating material is coated on the surface of the conductive micro particles. Hence, the substrate P after the discharging process is heated and/or irradiated with light. This thermal and/or optical treatment can be implemented by the previous burning conditions which were used in forming the gate electrode layer 80.

These above mentioned processes change the dried film after being discharged to a conductive film with securing electrical contact among micro particles. As shown in FIG. 8B, these above mentioned processes also form a source electrode 34 connected to one of the N⁺ silicon layer 85 and the drain electrode 35 connected to the other of the N⁺ silicon layer 85.

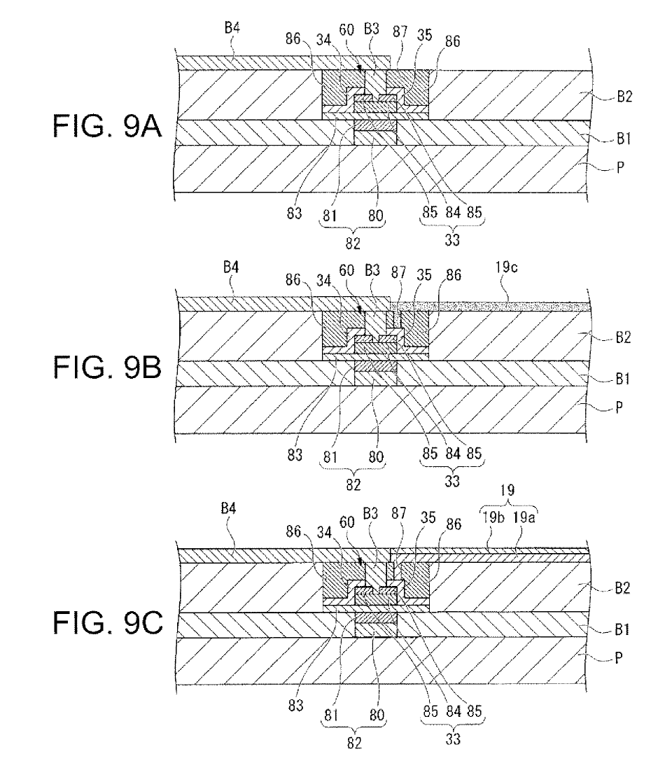

Next, an insulating material 86 is placed and filled into the concave area (the opening) as shown in FIG. 9A. Here, the concave area is partitioned by the second bank B2 and the third bank B3. The source electrode 34 and the drain electrode 35 are formed in the concave area.

Next, a contact hole 87 is formed in the insulation layer 86 on the drain electrode 35.

Next, the ink(polysilazane liquid) is discharged to predetermined positions on the second bank B2, the insulating material 86 and the third bank B3 from the droplet discharging head 301. Here, the ink made of the PL liquid is mainly composed of the above mentioned PL. Further, these predetermined positions are a position which partitions the region for forming the source electrode 19 and a region for forming the fourth bank B4. Here, the PL liquid can be selectively coated to a desired position by the sequential processing since the PL liquid is discharged to these predetermined positions by the droplet discharging head 301.

Thus, after the PL liquid is placed, the obtained PL thin film is preliminary baked with 110° C. and one minute on a hot plate for example if it is necessary.

Next, the film is burned with 300° C. and sixty minutes so as to form the fourth bank B4 Here, the film may be exposed to light and humidified before burning when a photo sensitive PL liquid including PL and PX is used as the ink of the PL liquid. These processes make it possible to easily change PL shown in the formula (1) to PM shown in the formulas (4) to (6). Accordingly the fourth bank B4 formed by these processes, is mainly made of PM as an inorganic material, showing fairly superior heat resistance comparing with a bank made of an inorganic material. But, the fourth bank B4 may be formed with a well known organic material(an organic resist) instead of after the PL liquid

Next, the surface property of the fourth bank B4 is modified into lyophobic by the lyophobic process, similarly to the first bank B1. Next, transparent ink (a first functional liquid) in which the conductive transparent micro particles are dispersed into a solvent is discharged to the region partitioned by the fourth bank B4 from the droplet discharging head 301 of the droplet-discharging device IJ. In the embodiment, the solution in which indium tin oxide (ITO) is dispersed into the solvent is used as the transparent ink. The surface property of the fourth bank B4 has already been lyophobic at this discharging, making a part of droplets slip into the inside of the partitioned region with being repelled from the surface of the bank even if such part of discharged droplets is placed on the fourth bank B4. In this process, it is preferable that the predetermined amount of the transparent ink be selectively discharged and placed on the opening of the contact hole 87 so as to preferably fill the transparent ink into the contact hole 87.

Thus, after coating the transparent ink within the fourth bank B4, the substrate is naturally dried for ten minutes. Then, the substrate P is inserted into the baking furnace and heated with the heating speed of 200° C./hr. and hold for thirty minutes with 550° C. Further, it is cooled down to the ambient temperature with the cooling speed of 200° C./hr. This heating (drying) forms the first layered film 19c made of the conductive micro particles as shown in FIG. 9B. Here, there are many vacant holes among micro particles (not shown in the figure) from microscopic view after forming the first layered film 19c since the first layered film 19c is an integration of transparent conductive micro particles.

Next, a second functional liquid including a silica compound is placed on the first layered film 19c by a liquid droplet discharging method. More specifically, an example of the silica compound is the micro particle compounds, which includes at least silicon atoms and easily oxidized by heating described later, such as heat decomposed siloxane silicate, PL, silicon and alcoxide. In the second functional liquid, a solvent dispersing the above mentioned chemical micro particles is used.

Then, after discharging and placing the second functional liquid on the first layered film 19c, the substrate is heated with the heating speed of 200° C./hr. and hold for thirty minutes with 550° C. Further, it is cooled down to the ambient temperature with the cooling speed of 200° C./hr. This heating integrally burns the first layered film 19c and the second functional liquid, forming the transparent conductive layer 19a, which is made of the first layered film 19c and silica oxide filled in holes within the first layered film as shown in FIG. 9c.

Here, regarding the transparent conductive layer 19a, the second functional liquid may not soak through the bottom of the first layered film 19c, forming the single first layered film 19c only without existing silica oxide at the bottom of the first layered film 19c. But, the transparent conductive layer 19a of the invention may comprise the single first layered film 19c only at the bottom, showing the same function and effect described later.

Further, in the above method of discharging and placing the second functional liquid, the amount of the discharged second functional liquid may be adjusted so as to form the silica oxide layer 19b made of the second functional liquid on the transparent conductive layer 19a. Here, the silica oxide layer 19b is formed after burning the second functional liquid and the first layered film 11c in a lump.

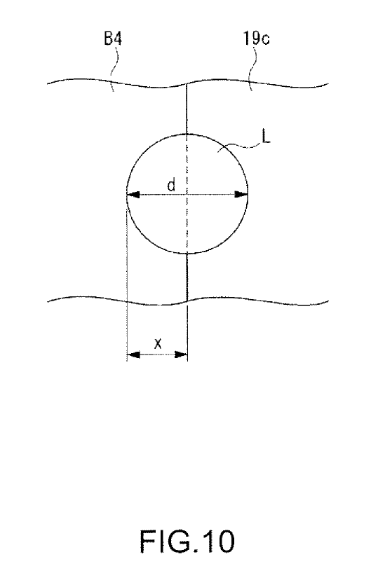

Here, as shown in FIG. 10, the functional liquid is discharged and placed on the first layered film 19c so that a part of the droplets stays on the fourth bank B4 when a droplet L of the second functional liquid is discharged in the vicinity of the bank.

Further, the droplet is preferably placed within the region expressed by the following formula:(d/2)≦x<d, where “d” is the radius of the discharged droplet and “x” is the length toward the direction of radius of the droplet placed onto the bank.

This placement makes most half of droplets having radius d allocated on the bank, certainly drop on the edge of the first layered film 19c contacting the fourth bank B4 and get there wet when these droplets fall down from the bank and stay on the first layered film 19c. Accordingly, the second functional liquid is filled over the entire surface of the first layered film 19c including the interface with the fourth bank B4 and the metal oxide material is filled into holes within the first layered film 19c. Finally the transparent conductive layer 19a is formed.

Namely, the transparent conductive layer 19a composed of the first layered film 19c and the silica oxide filled in holes in the film is formed. Further, the silica oxide layer 19b made of the second functional liquid is formed so as to form the pixel electrode 19 in which the transparent conductive layer 19a and the silica oxide layer 19b are sequentially deposited. Accordingly, the TFT 60 is formed inside of the glass substrate P (the upper side of it in the figure) and the pixel electrode 19 as the transparent conductive electrode of the invention is further formed. The thin film transistors array substrate 10 is completely formed.

According to the method of forming a transparent conductive film of the embodiment, the first functional liquid and the second functional liquid are placed in order in the region partitioned by the fourth bank B4 by the liquid droplet discharging method in order to form the pixel electrode 19. This method can accurately form and pattern the pixel electrode 19 even such the electrode is densely patterned, if the fourth bank B14 is preliminarily formed corresponding to the intended pattern of the pixel electrode.

Further, the pixel electrode 19 is formed within the fourth bank B4, covering the side end of the pixel electrode 19 with the bank B4. The method can constrain the change of conductivity of pixel electrode 19 due to humidifying the side edge without lowering the transparency of it.

Further, the fourth bank B4 is mainly composed of polysiloxane. This composition fairly improves the heat resistance of the bank B4 comparing a bank made of an organic material, for example and making it possible to burn the first layered film and the second functional liquid in a lump with relatively high temperature. Accordingly, the pixel electrode 19 composed of preferable sintered body can be formed.

Further, the pixel electrode 19 is formed by sequentially depositing the transparent conductive electrode 19a and the silica oxide 19b. This deposition makes the pixel electrode 19 hold the transparency, which is similar to a glass since the silica oxide 19b, has the same transparency of a glass. Accordingly, displaying characteristics of an electro optic device can be fairly improved when the pixel electrode 19 is used of the electro optic device since the refractivity between the pixel electrode 19 and the substrate P is sufficiently small if the substrate P is a glass.

Further, the liquid display device 100 provided with the TFT array substrate 10 is capable of displaying micro fine images since the pixel electrode 19 is micro densely miniaturized. Further, the device can display stabilized images since the change of the conductivity of transparent conductive films is constrained without lowering its transparency.

Next, other embodiment of the method of manufacturing a transparent conductive film of the invention is described as well as a method of manufacturing the TFT 60. The main difference of the embodiment from the previous one is that the method of forming the transparent conductive film of the invention is applied to not only the pixel electrode 19, but also wirings connected to it.

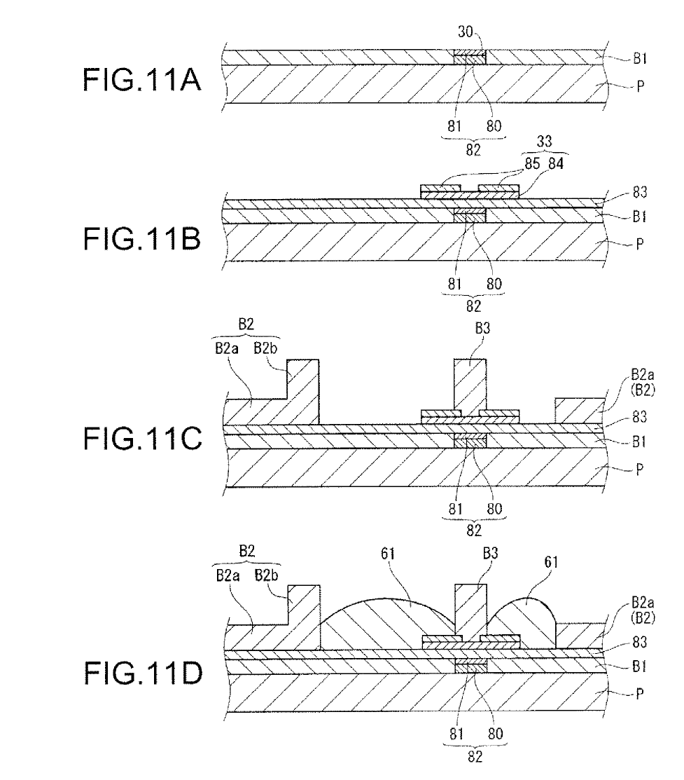

First, as shown in FIG. 11A, the conductive pattern 82 comprising the gate electrode 80 and the cap layer 81 is formed in the opening 30 of the first bank B1 similarly to the previous embodiment.

Next, the gate-insulating layer 83 made of nitride silicon is formed on the first bank B1 including the conductive pattern 82. The plasma CVD method preferably forms the layer. Here, a nitride silicon layer is formed in the entire surface of the substrate P and the following process is implemented without patterning the layer.

Then, the amorphous silicon film and the N⁺ silicon film are formed on the entire surface of the substrate P. Then they are patterned as the configuration shown in FIG. 11B by a photolithographic method, forming the semiconductor layer 33 on the gate insulating film 83 in which the amorphous silicon layer 84 and the N⁺ silicon layer 85 are sequentially deposited. Accordingly, the N⁺ silicon layer 85 is selectively removed and divided into two regions at the region where it is overlapped with the gate electrode layer 80 by the abovementioned patterning method, forming a source contact region and a drain contact region.

Next, the second bank B2 and the third bank B3 are formed as being provided with opening pattern shown in FIG. 11C similarly to the previous embodiment. In order to form the second bank B2 and the third bank B3, the photosensitive polysilazane liquid including polysilazane and photooxidation product is used as described before. In particular, the second bank B2 has a bump structure including the thin film portion B2a and thick film portion B2b, which are formed by half exposure after placing the photosensitive polysilazane liquid in a predetermined position. But, the thin film portion B2a is not formed on the source electrode region.

Next, the surface property of the second bank B2 and the third bank B3 is modified into lyophoblc by the lyophobic process, if it is necessary. As the lyophobic process, tetrafluoromethane is used for example as a processing gas with plasma processing (CF₄ plasma processing) under atmospheric air similarly to the previous embodiment.

Next, ink (a conductive material) is placed within the region surrounded by the second bank B2 and the third bank 133 via the droplet-discharging device IJ as shown in FIG. 11D. Then it is dried if it is necessary.

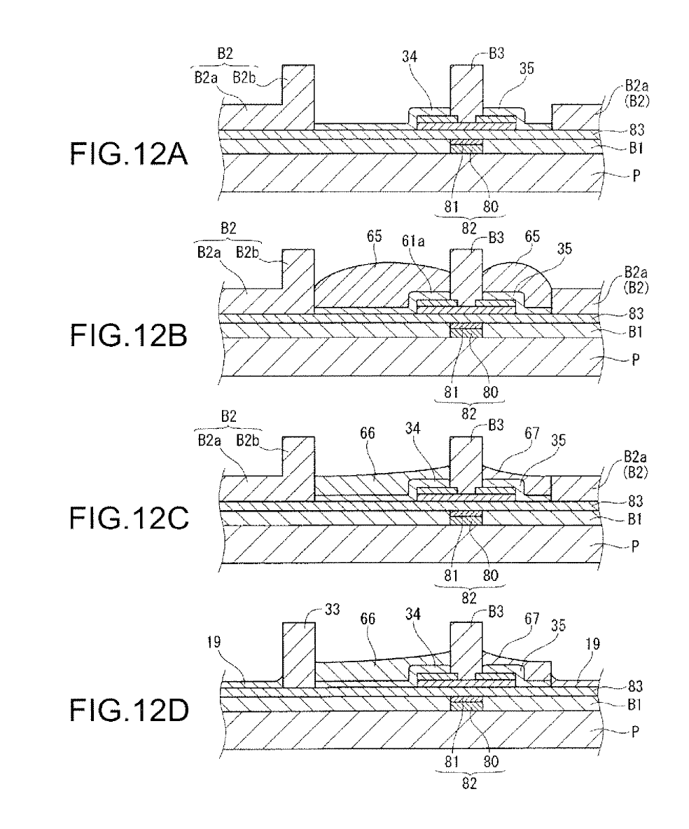

Next, it is heated and/or irradiated with light. Finally, as shown in FIG. 12A, the source electrode 34 connected to one of the N⁺ silicon layer 85 and the drain electrode 35 connected to the other of the N⁺ silicon layer 85 are formed.

Next, as shown in FIG. 12B, transparent ink (a first functional liquid) 65 in which the conductive transparent micro particles are dispersed into a solvent is discharged by the droplet-discharging device IJ. In the embodiment, the solution in which indium tin oxide (ITO) is dispersed into the solvent is used as the transparent ink.

Thus, after coating the transparent ink in the region surrounded by the second bank B2 and the third bank B3, the substrate is naturally dried for ten minutes, for example. Then, the substrate P is inserted into the baking furnace and heated with the heating speed of 200° C./hr. and hold for thirty minutes with 550° C. Further it is cooled down to the ambient temperature with the cooling speed of 200° C./hr. Finally the first layered film (not shown) is formed.

Next, a second functional liquid including a silica compound is placed on the first layered film by a liquid droplet discharging method. Then, after discharging and placing the second functional liquid on the first layered film, the substrate is heated with the heating speed of 200° C./hr. and hold for thirty minutes with 550° C. Further, it is cooled down to the ambient temperature with the cooling speed of 200° C./hr. This heating integrally burns the first layered film and the second functional liquid, forming the transparent conductive layer (not shown), which is made of the first layered film and silica oxide filled in holes within the first layered film as shown in FIG. 12c.

Further, in the above method of discharging and placing the second functional liquid, the amount of the discharged second functional liquid is adjusted so as to form the silica oxide layer made of the second functional liquid on the transparent conductive layer. Here, the silica oxide layer is formed after burning the second functional liquid and the first layered film in a lump. Accordingly, transparent conductive films 66 and 67 comprising a transparent conductive layer and a silica oxide layer are formed similarly to the previous embodiment by placing the transparent ink (the first functional liquid) and the second functional liquid with a droplet discharging method, then drying and burning them. Here, the transparent conductive film 67 is a wiring pattern to connect the drain electrode 35 with a pixel electrode not shown in the figure and the transparent conductive film 66 is a wiring pattern to connect the source electrode 61a with a source wiring not shown in the figure.

Here, as shown in FIG. 10, the second functional liquid is discharged and placed on the first layered film so that a part of the droplets stays on the bank when a droplet L of the second functional liquid is discharged in the vicinity of the bank. Further, the droplet is preferably placed within the region expressed by the following formula:(d/2)≦x<d, where “d” is the radius of the discharged droplet and “x” is the length toward the direction of radius of the droplet placed onto the bank. Furthers when the first functional liquid is discharged and placed, it is preferable that the above process is similarly applied.

Next, the thin film portion B2a of the second bank B2 is removed by etching for example. Then, the transparent ink and silica compound are placed in the region where the thin film portion B2a is removed by a droplet discharging method, similarly to the previous embodiment. The pixel electrode 19 comprising a transparent conductive layer and the silica oxide layer is formed as shown in FIG. 12D.

According to the method of forming transparent conductive films 66 and 67 of the embodiment, the first functional liquid and the second functional liquid are placed in order in the region partitioned by the second and third banks B2 and B3 by a liquid droplet discharging method in order to form transparent conductive films 66 and 67. This method can accurately form and pattern transparent conductive films 66 and 67 even when such the films are densely patterned, if the second and the third banks B2 and B3 are preliminarily formed corresponding to the intended pattern of transparent conductive films.

Further, transparent conductive films 66 and 67 are formed within the second and the third banks B2 and B3, covering the side end of these transparent conductive films 66 and 67. The method can constrain the change of conductivity of these transparent conductive films 66 and 67 due to humidifying the side edge without lowering the transparency of it.

Further, the second and the third banks 32 and B3 are mainly composed of polysiloxane. This composition fairly improves the heat resistance of the second and the third banks B2 and B3 comparing to a bank made of an organic material, for example and making it possible to burn the first layered film and the second functional liquid in a lump with relatively high temperature. Accordingly, these transparent conductive films 66 and 67 composed of preferable sintered body can be formed.

Further, a nitride silicon film is preliminary formed as the gate insulating film 83 of the TFT 60 and then these transparent conductive films 66 and 67 are formed on an entire surface of the nitride silicon film without pattering the film. This method simplifies the manufacturing process and improves productivity.

The present invention is applied to not only the liquid crystal display device 100, but also various kinds of electro optical devices. The invention is preferably applied to an organic electro luminescent display, a plasma display and the like, for example.

Electronic Instrument

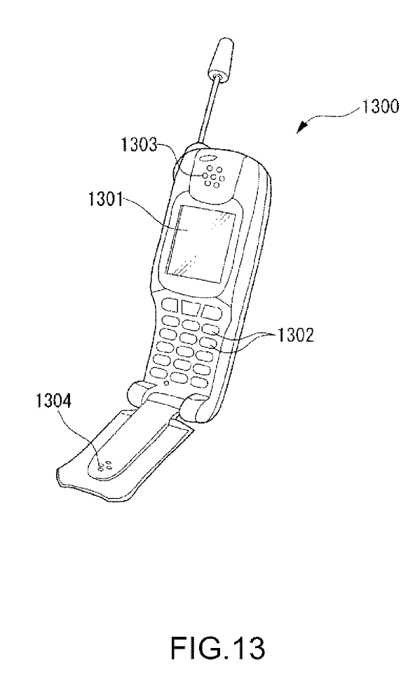

FIG. 13 is a perspective view showing an electronic instrument according to the embodiment of the invention. A mobile phone 1300 is provided with a small display 1301 as the liquid crystal display of the invention, plural operating buttons 1302, a receiver 1303 and a mouthpiece 1304.

The electro optical device of the above embodiment is preferably used as an image display, which is applied to not only the above mobile phone, but an electronic book, a computer, a digital still camera, a video monitor, a vide tape recorder with a view finder or a direct view monitor, automobile navigation device, a pager, an electronic notebook, an electronic calculator, a word processor, a work station, a TV phone, a POS terminal and a touch panel.

These electronic instruments can display fine and stable images by themselves since the above mentioned electro optic device display accurate, fine and stable images.

What is claimed is:

1. A method of forming a transparent conductive film on a substrate, comprising:
forming a bank with a material including polysiloxane as a main component wherein the bank corresponds to a region for forming the transparent conductive film;
placing a first functional liquid including transparent conductive micro particles in a region partitioned by the bank by a liquid droplet discharging method;
forming a first layered film by drying the first functional liquid;
placing a second functional liquid including a metal compound on the first layered film by a liquid droplet discharging method;
forming a transparent conductive layer composed of the first layered film and a metal oxide material, which is filled in holes formed in the first layered film, by burning the first layered film and the second functional liquid in a lump.

2. The method of forming a transparent conductive film according to claim 1, wherein the first layered film and the second functional liquid are burned in a lump under an inactive atmosphere or a reducing atmosphere.

3. The method of forming a transparent conductive film according to claim 1, the first functional liquid is dried in an atmospheric air.

4. The method of forming a transparent conductive film according to claim 1, wherein a photosensitive polysilazane liquid or a photosensitive polysiloxan liquid functioning as a positive photo resist, and including photooxidation product is coated on the substrate, exposed, developed, patterned, and then burned so as to form the bank.

5. The method of forming a transparent conductive film according to claim 1, wherein the amount of the discharged second functional liquid is adjusted so as to form a metal oxide layer made of the second functional liquid on the transparent conductive layer after burning the second functional liquid and the first layered film in a lump.

6. The method of forming a transparent conductive film according to claim 1, wherein the second functional liquid is placed on the first layered film by a liquid droplet discharging method, so that a part of the second functional liquid droplet is discharged onto the bank when the second functional liquid is discharged in the vicinity of the bank, wherein the droplet is preferably placed within the region expressed by the following formula:(d/2)≦x<d, where “d” is the radius of the discharged droplet and “x” is the length toward the direction of radius of the droplet placed onto the bank.

7. The method of forming a transparent conductive film according to claim 1, wherein a nitride silicon film is preliminarily formed on the substrate.

8. A transparent conductive film comprising:
a substrate;
a bank of which main material is polysiloxan on the substrate; and
a transparent conductive layer that includes a first layered film and a metal oxide layer to be filled into holes within the first layered film, and is formed in the region partitioned by the bank.

9. The transparent conductive film according to claim 8, wherein a metal oxide layer is formed on the transparent conductive film with covering over the transparent conductive layer.

10. An electro optic device of the invention comprising the transparent conductive film according to claim 8, or obtained by the method of forming a transparent conductive film according to claim 1.

11. An electronic instrument comprising the electro optic device according to claim 10.
